(19) United States
(12) Patent Application Publication
(10) Pub. No.: US 2003/0125226 A1
(43) Pub. Date: Jul. 3, 2003

(54) Anti-slip floor coating remover composition

(76) Inventor: Paul F. Lewis, Lake Geneva, WI (US)

Correspondence Address: S.C. JOHNSON COMMERCIAL MARKETS INC, 8310 16TH STREET, M/S 510, PO BOX 902, STURTEVANT, WI, 53177-0902, US

(21) Appl. No.: 10/339,239

(22) Filed: Jan. 9, 2003

Related U.S. Application Data
(63) Continuation-in-part of application No. 09/724,213, filed on Nov. 28, 2000.

(51) Int. Cl. C11D 1/00

(52) U.S. Cl. 510/214

(57) ABSTRACT

A floor coating remover composition with abrasive and reduced slip properties under foot. Solid plastic, natural stone or other inorganic or organic grit is incorporated into a floor coating removing formulation to provide a coefficient of friction so that slippage under foot during use is reduced. In the instance of the presence of natural stone grit or other inorganic grit, a stabilizer may be employed to keep the grit in suspension.

### CROSS-REFERENCE TO RELATED APPLICATIONS

This is a Continuation-in-Part of Ser. No. 09/724,213, Filed Nov. 28,2000.

### STATEMENT REGARDING FEDERALLY SPONSORED RESEARCH OR DEVELOPMENT

None

### BACKGROUND OF THE INVENTION

This invention relates generally to a composition for removing a floor coating. More particularly, it relates to such a composition which reduces the incidence of slippage under foot during use.

### BACKGROUND ART

When stripping a floor finish or floor coating with a chemical composition in many instances, the floor becomes extremely slippery underfoot. Numerous slips and falls have resulted. Accordingly, it is desirable to have a floor coating or floor finish remover composition which reduces the incidence of slippage under foot.

In U.S. Pat. No. 1,785,417 a paint and varnish remover is disclosed wherein an abrasive agent in the form of disintegrated mineral particles is added to the remover as an optional ingredient.

In U.S. Pat. No. 5,096,610 there are disclosed floor finish remover compositions in which an organosilicon complex is incorporated for the purpose of accelerating floor finish removal.

### BRIEF DESCRIPTION OF THE DRAWINGS

FIG. 1 is a bar graph depicting wet coefficient of friction in conjunction with the levels of grit employed in the anti-slip floor coating remover composition of this invention.

### SUMMARY OF THE INVENTION

The prior art does not provide a composition for removing a floor coating or floor finish which reduces the incidence of slippage under foot during use. As employed hereinafter, the term “Floor Coating” is also meant to include floor finishes, floor polishes and floor waxes.

It is an object of the invention to provide a composition for removing a floor coating which reduces the incidence of slippage under foot.

It is another object of the invention to provide a composition of the foregoing type which is adaptable to a wide variety of floor coating remover formulations.

It is yet still another object of the invention to provide a composition of the foregoing type which is adaptable to a wide variety of abrasive materials.

It is yet another object of the invention to provide a composition of the foregoing type containing an abrasive material wherein the abrasive material is stabilized in the composition.

These and still other objects and advantages of the invention will be apparent from the description which follows. In the detailed description below in the examples preferred embodiments of the invention will be described in reference to the full scope of the invention. Rather, the invention may be employed in other embodiments.

The foregoing objects are accomplished in one aspect by the floor coating remover composition with abrasive and reduced slip properties which includes a floor coating stripper formulation and a solid plastic, solid natural stone grit, other solid inorganic or solid organic grit. Depending on the density of the plastic or the grit, a stabilizer is present.

In another aspect, the solid plastic is polyallyl diglycol carbonate.

In yet another aspect, the solid plastic is styrene acrylonitrile.

In still another aspect, the solid plastic is cross linked polyvinyl chloride.

In yet another aspect, the solid plastic is cross linked urea formaldehyde.

In still another aspect, the solid plastic is nylon.

In yet another aspect, the natural stone is aluminum oxide.

In still another aspect, the stabilizer is a thickener.

### DESCRIPTION OF PREFERRED EMBODIMENTS

The compositions of the present invention are adaptable to a wide variety of floor coating formulations. In a preferred manner and in one embodiment, the stripper formulation in the floor coating remover composition includes a glycol ether such as ethylene glycol n-hexyl ether, ethylene glycol monobutyl ether and propylene glycol phenyl ether.

In another preferred embodiment, the stripper formulation includes benzyl alcohol.

In yet another preferred embodiment, the stripper formulation includes a hydroxide such as sodium or ammonium hydroxide. Specific formulas 1, 1A-C and 2 are described in the following Tables I and II:

TABLE I
FORMULA 1

| INGREDIENT NAME | WT % |
|---|---|
| DEIONIZED WATER | 71.7 |
| ETHYLENE GLYCOL MONOBUTYL ETHER | 15.0 |
| MONOETHANOLAMINE | 4.0 |
| CAUSTIC SODA, 50%, LIQUID | 4.0 |
| SODIUM XYLENE SULFONATE, 40% | 3.0 |
| TETRASODIUM SALT OF EDTA | 1.0 |
| LUBRUOPHOS LP-700 SURFACTANT* | 0.8 |
| AMMONIUM HYDROXIDE - 28% | 0.3 |
| SURFYNOL 104H SURFACTANT** | 0.2 |
| TOTAL PERCENT: | 100.0 |

*Available from Rhodia Inc., Cranbury, New Jersey.
**Available from Air Products and Chemicals, Inc., Allentown, Pennsylvania.

FORMULA 1A

| INGREDIENT NAME | WT % |
|---|---|
| MONOETHANOLAMINE | 30.0 |
| ETHYLENE GLYCOL n-HEXYL ETHER | 25.0 |
| BENZYL ALCOHOL | 25.0 |
| NEODOL 91-6 SURFACTANT* | 7.0 |
| TALL OIL FATTY ACID | 5.0 |
| WATER | 8.0 |
| TOTAL PERCENT: | 100.0 |

*Available from Shell Corporation

FORMULA 1B

| INGREDIENT NAME | WT % |
|---|---|
| WATER | 66.8 |
| PROPYLENE GLYCOL PHENYL ETHER | 11.0 |
| SODIUM XYLENE SULFONATE | 8.0 |
| MONOETHANOLAMINE | 6.0 |
| SODIUM SILICATE SOLUTION | 2.0 |
| LUBROPHOS LP-700 SURFACTANT | 2.0 |
| BUTYL PROPASOL | 2.0 |
| SODIUM HYDROXIDE | 1.0 |
| TETRASODIUM SALT OF EDTA | 1.0 |
| FLUORAD FC120 SURFACTANT* | 0.2 |
| TOTAL PERCENT: | 100.0 |

*Available from 3M Corporation

FORMULA 1C

| INGREDIENT NAME | WT % |
|---|---|
| WATER | 73.1 |
| SODIUM XYLENE SULFONATE | 2.0 |
| MONOETHANOLAMINE | 4.0 |
| SODIUM SILICATE SOLUTION | 10.0 |
| LUBROPHOS LP-700 SURFACTANT | 0.9 |
| SODIUM HYDROXIDE | 9.0 |
| TETRASODIUM SALT OF EDTA | 0.8 |
| FLUORAD FC120 SURFACTANT* | 0.2 |
| TOTAL PERCENT: | 100.0 |

*Available from 3M Corporation

TABLE II
FORMULA 2

| INGREDIENT NAME | WT % |
|---|---|
| DEIONIZED WATER | 66.4 |
| ETHYLENE GLYCOL MONOBUTYL ETHER | 13.9 |
| MONOETHANOLAMINE | 3.7 |
| CAUSTIC SODA - 50% | 3.7 |
| SODIUM XYLENE SULFONATE - 40% | 2.8 |
| TETRASODIUM SALT OF EDTA | 0.9 |
| LUBRHTOPHOS 700 - SURFACTANT | 0.7 |
| AMMONIUM HYDROXIDE - 28% | 0.3 |
| SURFYNOL 104H SURFACTANT | 0.2 |
| ACUSOL 820 - ASSOCIATIVE THICKENER* | 7.4 |
| TOTAL PERCENT | 100.0 |

*Available from Rohm & Haas Co., Spring Grove, Pennsylvania.

A grit material is incorporated in the above Formulas 1, 1A-C or 2 either before or after they are diluted with water. In the instance where the grit is a solid organic material such as a cellulosic grit or an organic plastic material such as polyallyl diglycol carbonate or crosslinked polyvinyl chloride either Formula I or Formula 2 may be employed. In the instance where the grit is a solid inorganic material such as aluminum oxide, silica sand or pumice, or natural stone, Formula 2 may be preferred with the stabilizer thickening agent.

Mixing & Usage Procedure

The anti-slip additive (grit) can be mixed into the above Formulas 1, 1A-C. and 2 and used in one of the following ways:

1. Premixed into the stripper formulation, with or without a stabilizing additive (thickener). The stripper is then mixed with water immediately prior to use and applied onto the floor. Occasional gentle stirring may be needed to redisperse the grit. Stripping of the floor finish is continued in the usual way.

2. Floor finish stripper is mixed with water and applied onto the floor in the usual way. Grit is broadcast into the wet stripper formulation, either by hand or using a piece of equipment. Stripping of the floor finish is continued in the usual way.

3. Floor finish stripper is mixed with water. Grit is added to the stripper formulation and stirred lightly with the mop or other application device. This is applied onto the floor in the usual way, gently stirring occasionally, as needed to redisperse the grit. Stripping of the floor finish is continued in the usual way.

4. A thickened floor finish stripper formulation as set forth in Formula 2 is mixed with water. Grit is added to the stripper solution & stirred lightly with the mop or other application device. This is applied onto the floor in the usual way. Stripping of the floor finish is continued in the usual way.

5. Floor finish stripper is mixed with water. A special blend of a grit and a thickener is added to the stripper solution & stirred with the mop or other application device. This is applied onto the floor in the usual way. Stripping of the floor finish is continued in the usual way. The special blend of grit and thickener is 61.5 parts by weight of Acrysol 820 and 38.5 parts by weight of an anti-slip grit such as ResNSand 34SG.

The preferred approaches are 1, 3 or 4.

Several formulas were evaluated for wet coefficient of friction. Testing was carried out as follows:

Four coats of Premia floor finish available from S. C. Johnson Commercial Markets, Inc., Sturtevant, Wisconsin, were applied to vinyl composition tile floor. One part of the Bravo floor finish remover available from S. C. Johnson Commercial Markets, Inc. was mixed with four parts of water (diluted in this way, this stripper is referred to as Bravo in subsequent tables). The formula for Bravo is essentially the same as Formula 1C. ResNSand grit was incorporated therein. The ResNSand products used in the following Tables are available from American Fillers & Abrasives Inc., Bangor, Michigan. The chemical compositions of the polymeric grits tested are as follows:

ResNSand 34S: Polyallyl diglycol carbonate

ResNSand 34H: Styrene acrylonitrile

ResNSand 87P: Cross linked polyvinyl chloride

ResNSand 69N: Cross linked urea formaldehyde

The second letter with the number indicates particle size.

The Vydyne product is nylon available from Solutia Inc., St. Louis, Mo.

Using a Brungraber MK2 slip tester each of the samples was tested for its wet coefficient of friction (CoF), with different mesh sizes. The results are given below in Table III.

TABLE III

| Example | Description | Amounts | Grit Size | Wet CoF |
|---|---|---|---|---|
| 1. | Bravo | 720 grams | 20-30 Mesh | 0.15-0.16 |
| | ResNSand 34SD | 80 grams | | |
| 2. | Bravo | 720 grams | 30-40 Mesh | 0.17-0.19 |
| | ResNSand 34SE | 80 grams | | |
| 3. | Bravo | 720 grams | 60-80 Mesh | 0.21-0.25 |
| | ResNSand 34SF | 80 grams | | |
| 4. | Bravo | 720 grams | 100 Mesh | 0.15-0.17 |
| | ResNSand 34SG | 80 grams | | |
| 5. | Bravo | 720 grams | <100 Mesh | 0.19-0.20 |
| | ResNSand 34SH | 80 grams | | |
| 6. | Bravo | 720 grams | 325 Mesh | 0.27-0.29 |
| | ResNSand 34SJ | 80 grams | | |
| 7. | Bravo | No Grit | | 0.03-0.05 |
| | NO GRIT | | | |

Further evaluation of wet coefficient of friction of grit/stripper mixtures with ResNSand 34SG are shown in Table IV. Three coats of Premia floor finish were applied to vinyl composition tile floor and allowed to dry for two weeks. The grit/stripper blends were shaken and poured onto the floor. These blends were of six types.

Using the Brungraber MK2 slip tester each of the samples was tested for its wet coefficient of friction, (CoF), with the results being given below.

TABLE IV

| Example | Description | Amounts | Grit Size | Wet CoF |
|---|---|---|---|---|
| 8. | Bravo | 999 grams | 100 Mesh | 0.05-0.07 |
| | ResNSand 34SG | 1 gram | | |
| 9. | Bravo | 997 grams | 100 Mesh | 0.08-0.1 |
| | ResNSand 34SG | 3 grams | | |
| 10. | Bravo | 990 grams | 100 Mesh | 0.13-0.16 |
| | ResNSand 34SG | 10 grams | | |
| 11. | Bravo | 970 grams | 100 Mesh | 0.16-0.17 |
| | ResNSand 34SG | 30 grams | | |
| 12. | Bravo | 900 grams | 100 Mesh | 0.19-0.22 |
| | ResNSand 34SG | 100 grams | | |
| 13. | Bravo | 700 grams | 100 Mesh | 0.19-0.21 |
| | ResNSand 34SG | 300 grams | | |
| 14. | Bravo | 1000 grams | N/A | 0.03 |
| | NO GRIT | | | |

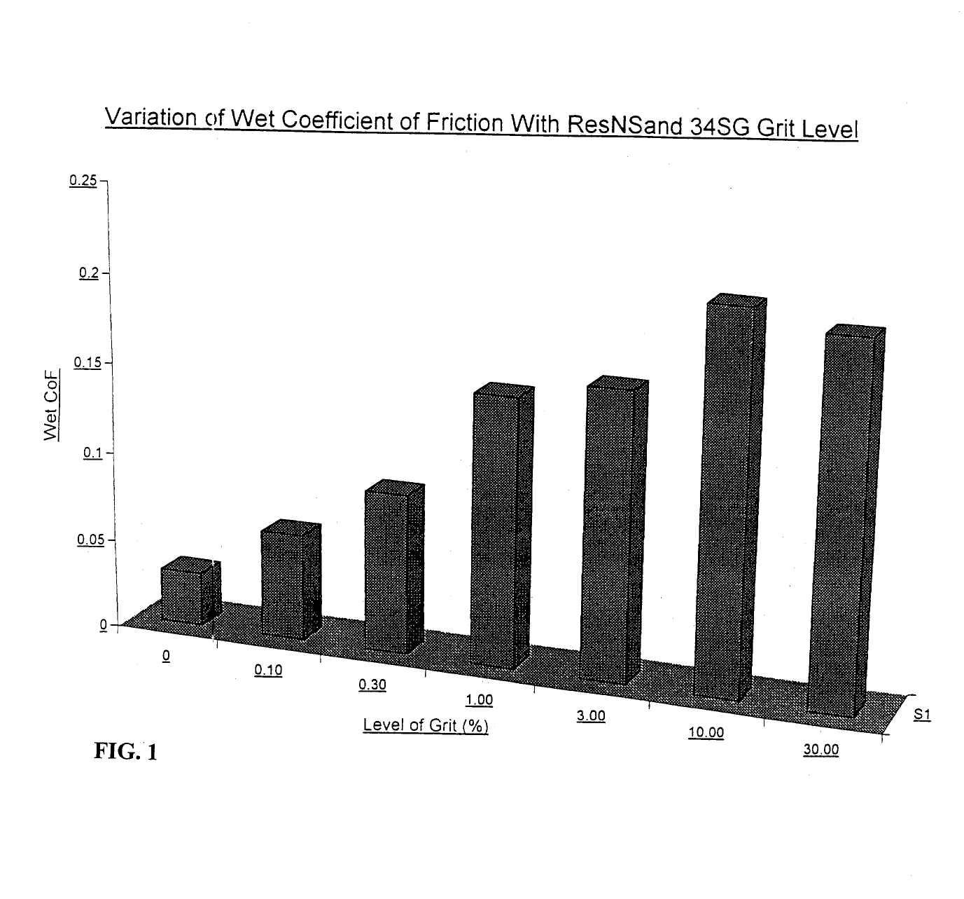

These results are plotted in the bar graph shown in FIG. 1. They show that a 10% grit level is an optimum amount.

Still further evaluations of wet coefficient of friction of grit/stripper mixtures were carried out as shown in TABLE V.

Three coats of Premia floor finish were applied to vinyl composition tile floor. The next day the grit/stripper mixtures were agitated and poured onto the floor. Eight grits with different chemical composition and particle size were mixed with Bravo floor finish remover. Using the Brungraber MK 2 slip tester, each of the samples was tested for its wet coefficient of friction (CoF) with the results being given below.

TABLE V

| Example | Description | Amounts | | Grit % | Grit Size | Wet CoF |
|---|---|---|---|---|---|---|
| 15 | Bravo | 798 | grams | 3% | 20-30 mesh | 0.10-0.12 |
| | ResNSand 34SD | 2.4 | grams | | | |
| 16 | Bravo | 640 | grams | 20% | 20-30 mesh | 0.15-0.17 |
| | ResNSand 34SD | 160 | grams | | | |
| 17 | Bravo | 798 | grams | 3% | 40-60 mesh | 0.15-0.16 |
| | ResNSand 34HF | 2.4 | grams | | | |
| 18 | Bravo | 640 | grams | 20% | 40-60 mesh | 0.19-0.22 |
| | ResNSand 34HF | 160 | grams | | | |
| 19 | Bravo | 798 | grams | 3% | 325 mesh | 0.10-0.12 |
| | ResNSand 34SJ | 2.4 | grams | | | |
| 20 | Bravo | 640 | grams | 20% | 325 mesh | 0.11-0.13 |
| | ResNSand 34SJ | 160 | grams | | | |
| 21 | Bravo | 640 | grams | 20% | 12-16 mesh | 0.14-0.16 |
| | ResNSand 34SC | 160 | grams | | | |
| 22 | Bravo | 798 | grams | 3% | 100 mesh | 0.14-0.15 |
| | ResNSand SG | 2.4 | grams | | | |
| 23 | Bravo | 640 | grams | 20% | 100 mesh | 0.17-0.19 |
| | ResNSand SG | 160 | grams | | | |
| 24 | Bravo | 798 | grams | 3% | 40-60 mesh | 0.13-0.14 |
| | ResNSand 87PF | 2.4 | grams | | | |
| 25 | Bravo | 640 | grams | 20% | 40-60 mesh | 0.17-0.20 |
| | ResNSand 87PF | 160 | grams | | | |
| 26 | Bravo | 798 | grams | 3% | 40-60 mesh | 0.12-0.15 |
| | ResNSand 69NF | 2.4 | grams | | | |
| 27 | Bravo | 640 | grams | 20% | 40-60 mesh | 0.20-0.22 |
| | ResNSand 69NF | 160 | grams | | | |
| 28 | Bravo | 798 | grams | 3% | 40-60 mesh | 0.13-0.15 |
| | Vydyne 40-60 mesh | 2.4 | grams | | | |
| 29 | Bravo | 640 | grams | 20% | 40-60 mesh | 0.16-0.18 |
| | Vydyne 40-60 mesh | 160 | grams | | | |

| | | | | |
|---|---|---|---|---|
| 30 | Bravo | N/A | 0% | 0.06-0.08 |

Table VI illustrates scrub tests conducted on vinyl tile using 10 grams of grit for 30 cycles. The purpose of these tests was to evaluate what damage could be caused by different grits.

Black vinyl composition tiles were cut into sections and subjected to 30 cycles (back and forth scrubbing by hand pressure as shown in Examples 31-35 (10 grams each) with a white polishing pad and given a number based on the damage that was made, 1 equaling the most damaging and 10 showing no damage at all. Examples 36-40 show five different types of scrubbing pads with no grit present and the same grading scale.

TABLE VI
SCRUB TEST

| EXAMPLE | GRIT | NUMBER |
|---|---|---|
| 31 | ResNSand 34HF/White Pad | 10 |
| 32 | ResNSand 34SF/White Pad | 8 |
| 33 | ResNSand 89PF/White Pad | 10 |
| 34 | ResNSand 69NF/White Pad | 7 |
| 35 | White Aluminum Oxide 46 grit/White Pad | 1 |
| 36 | No grit/Blue Pad | 7 |
| 37 | No grit/Green Pad | 6 |
| 38 | No grit/Red Pad | 6 |
| 39 | No grit/Black Pad | 5 |
| 40 | No grit/White Pad | 10 |

Observations on Data:

Regardless of the chemical composition of the grit or its particle size, CoF values obtained were higher than that of a stripper formulation containing no grit. CoF values obtained with the 20% grit consistently exceeded those obtained with 3% grit.

It will thus be seen that there is now provided an anti-slip floor coating remover composition. While the composition is described in conjunction with five basic formulas, it can be employed with any floor finish remover having a stripper formulation which is water soluble including those which are solvent based or water dispersible.

While many types of grit particles have been evaluated in the anti-slip stripper composition of this invention, those particles which are somewhat angular in nature are preferred. It is theorized that the angular nature is important in the effectiveness. Other solid polymeric grits or inorganic grits will perform equally effectively.

Although any chemical type of solid grit can be used, the styrene acrylonitrile and cross-linked polyvinyl chloride are preferred as they have been shown to abrade the coating film in the stripping process, while effecting minimal damage to the vinyl composition tile underneath. Other solid grit particles such as a solid organic grit in the form of a cellulosic material available from American Fillers and Abrasives Inc., which also provide an anti-slip benefit, whether or not they abrade tile, can also be employed in this invention.

Any level of solid grit has been shown to have a positive effect on the anti-slip attributes between 0.1% and 30%, based on total diluted stripper. A level of 10% appears to be optimal. Additional testing showed that 50% grit also provided the same benefit, but that handling and foam of the stripper/grit blend was compromised adversely.

With regard to mesh sizes, it has been shown that particles in the range of 12 US mesh to 325 US mesh have a positive effect on the wet slip resistance. Particles larger than 12 US mesh as well as those less than 325 US are also effective.

Other variations and modifications of this invention will be obvious to those skilled in this art. This invention is not to be limited except as set forth in the following claims.

1. A floor coating remover composition with abrasive and reduced slip properties under foot comprising:
a floor coating remover composition composed of a floor coating stripper formulation and a solid plastic, solid natural stone grit, solid inorganic or solid organic grit, said solid plastic, solid natural stone grit, solid inorganic or solid organic grit being present in an amount to reduce the incidence of slippage under foot.

2. The remover composition of claim 1 further including a stabilizer.

3. The remover composition of claim 1 wherein only the solid plastic is present.

4. The remover composition of claim 3 wherein the solid plastic is polyallyl diglycol carbonate.

5. The remover composition of claim 3 wherein the solid plastic is styrene acrylonitile.

6. The remover composition of claim 3 wherein the solid plastic is cross linked polyvinyl chloride.

7. The remover composition of claim 3 wherein the solid plastic is cross linked urea formaldehyde.

8. The remover composition of claim 3 wherein the solid plastic is nylon.

9. The remover composition of claim 1 wherein only the solid inorganic grit is present.

10. The remover composition of claim 9 further including a stabilizer.

11. The remover composition of claim 10 wherein the stabilizer is a thickening agent

12. The remover composition of claim 10 wherein the inorganic grit is aluminum oxide.

13. The remover composition of claim 1 wherein only the solid natural stone is present.

14. The remover composition of claim 1 wherein only the solid organic grit is present and it is a cellulosic material.

15. The remover composition of claim 1 wherein the stripper formulation includes a glycol ether.

16. The remover composition of claim 1 wherein the stripper formulation includes benzyl alcohol.

17. The remover composition of claim 1 wherein the stripper formulation includes a hydroxide.

18. A method of stripping a floor coating comprising contacting the floor coating with the composition of claim 1.
